(19) United States
(12) Patent Application Publication
(10) Pub. No.: US 2011/0266120 A1
(43) Pub. Date: Nov. 3, 2011

(54) CONTACT DEVICE

(75) Inventors: Shinichiro Nakauchi, Tokyo (JP); Yoshinori Shimizu, Tokyo (JP); Hiroyuki Nakagawa, Tokyo (JP); Hideaki Shimazu, Tokyo (JP)

(73) Assignee: MITSUBISHI ELECTRIC CORPORATION, Chiyoda-ku (JP)

(21) Appl. No.: 13/142,880

(22) PCT Filed: Feb. 13, 2009
(86) PCT No.: PCT/JP2009/052422

§ 371 Date: Jun. 30, 2011

(51) Int. Cl. H01H 1/36

(52) U.S. Cl. 200/252

(57) ABSTRACT

A contact device includes a first conductor and a second conductor disposed with the first conductor on a common axis and having a fitting hole into which the first conductor can be inserted. At least one of the conductors is axially moved to fit the conductors together so that a current is allowed to flow between the conductors through contacts. The contact device further includes: a conductive coil spring that is disposed circumferentially on an outer circumferential surface of the first conductor and is contactable with an inner circumferential surface of the fitting hole; and a conductive coil spring that is disposed circumferentially on the inner circumferential surface of the fitting hole and is contactable with the outer circumferential surface of the first conductor.

### TECHNICAL FIELD

The present invention relates to a contact device that can bring a pair of connectable-disconnectable conductors into contact with each other through contacts to allow a current to flow between the conductors.

### BACKGROUND ART

For example, as a conventional contact device for a gas insulated switch, a known device includes a pair of conductors that are disposed coaxially and axially moved to fit their end portions together so that a current is allowed to flow between the pair of conductors through conductive contacts at the fitting surfaces. These contacts are disposed on the fitting surface of either one of the pair of conductors and come into sliding contact with the fitting surface of the other conductor when the conductors are fitted together. For large current devices or the like, a plurality of contacts are generally disposed on a fitting surface, and these contacts are axially spaced apart from each other at predetermined intervals to ensure current carrying capacity between the conductors.

Patent document 1 discloses a bus connecting device having a structure different from that of the above contact device. This bus connecting device includes a connecting conductive member for connecting a pair of insulated buses. This connecting conductive member has a through hole formed thereinside, and insertion conductors screwed and connected to the ends of the insulated buses are inserted into the through hole. The outer periphery of each insertion conductor includes a large-diameter portion formed on the screwed side and a small-diameter portion formed on the end side. A contact that comes into contact with the inner surface of the through hole is provided on the outer circumference of the large-diameter portion of each insertion conductor. A spring contact is attached to substantially the center of the through hole. Each end of the spring contact comes into contact with the outer circumference of the small-diameter portion of each of the insertion conductors, and the central portion of the spring contact is in contact with the inner surface of the through hole. With this structure, assembly errors and the expansion-contraction of the buses are absorbed sufficiently. This may ensure reliable contact between the contacting parts and improve the workability during bus connecting work.

### PRIOR ART DOCUMENT

### Patent Document

Patent document 1: Japanese Patent Application Laid-open No. S58-119710

### DISCLOSURE OF INVENTION

### Problem to be Solved by the Invention

In the above conventional contact device, however, the contacts are disposed on the fitting surface only of either one of the pair of the conductors. Generally, a plurality of contacts are provided to ensure current carrying capacity between conductors. Therefore, in such a case, a plurality of contacts successively come into sliding contact with a single contact area on the opposite fitting surface and move when the fit is made. This causes a problem in that the damage to the opposite fitting surface increases.

In Patent document 1, different contacts are used for the large-diameter portions and the small-diameter portions, and the contact areas for the different contacts are separated from each other. However, the bus connecting device is provided for the structure for bus connection between insulated buses, and this structure is essentially different from the structure for opening-closing an open-close section by sliding-contact of contacts. Therefore, this bus connecting device does not solve the problem in the conventional contact device.

The present invention has been made in view of the above circumstances, and it is an object of the present invention to provide a contact device that can reduce the damage to contact surfaces caused by sliding of contacts.

### Means for Solving Problem

In order to solve the aforementioned problem and attain the aforementioned object, a contact device according to one aspect of the present invention is constructed in such a manner as to include: a first conductor and a second conductor disposed with the first conductor on a common axis and having a fitting hole into which the first conductor can be inserted, at least one of the first and second conductors being axially moved to fit the first and second conductors together so that a current is allowed to flow between the first and second conductors through contacts, and the contact device is constructed in such a manner as to further include: a conductive first contact that is disposed circumferentially on an outer circumferential surface of the first conductor and is contactable with an inner circumferential surface of the fitting hole, and a conductive second contact that is disposed circumferentially on the inner circumferential surface of the fitting hole and is contactable with the outer circumferential surface of the first conductor.

### Effect of the Invention

In the present invention, a contact is provided for each of the pair of conductors. Therefore, when the conductors are fitted together, the first contact slides on the inner circumferential surface of the fitting hole, and the second contact slides on the outer circumferential surface of the first conductor. This allows the fitting-surface damage caused by the sliding of the contacts to be distributed to the inner circumferential surface and the outer circumferential surface. Therefore, an effect is demonstrated in that the damage to the fitting surfaces caused by the sliding of the contacts can be reduced as compared to that in the conventional structure in which both the first and second contacts are disposed on either one of the conductors.

### BRIEF DESCRIPTION OF DRAWINGS

FIG. 1 is a series of vertical cross sectional views of a contact device according to a first embodiment.

FIG. 2 is a series of vertical cross sectional views of a conventional contact device.

FIG. 3 is a series of vertical cross sectional views of a contact device according to a second embodiment.

FIG. 4 is a vertical cross sectional view of a contact device according to a third embodiment.

### EXPLANATIONS OF LETTERS OR NUMERALS

1, 2, 5 Conductor
3, 4, 7, 8 Fitting groove
6 Protrusion
10 to 12, 30 Contact device
15, 20, 45 Fitting hole
16, 17 Region
18 End portion
19 Base portion
A1, B1 Coil spring contact
Z Axis line

### BEST MODE(S) FOR CARRYING OUT THE INVENTION

Embodiments of a contact device according to the present invention will be described below in detail with reference to the accompanying drawings. However, the invention is not limited to these embodiments.

### First Embodiment

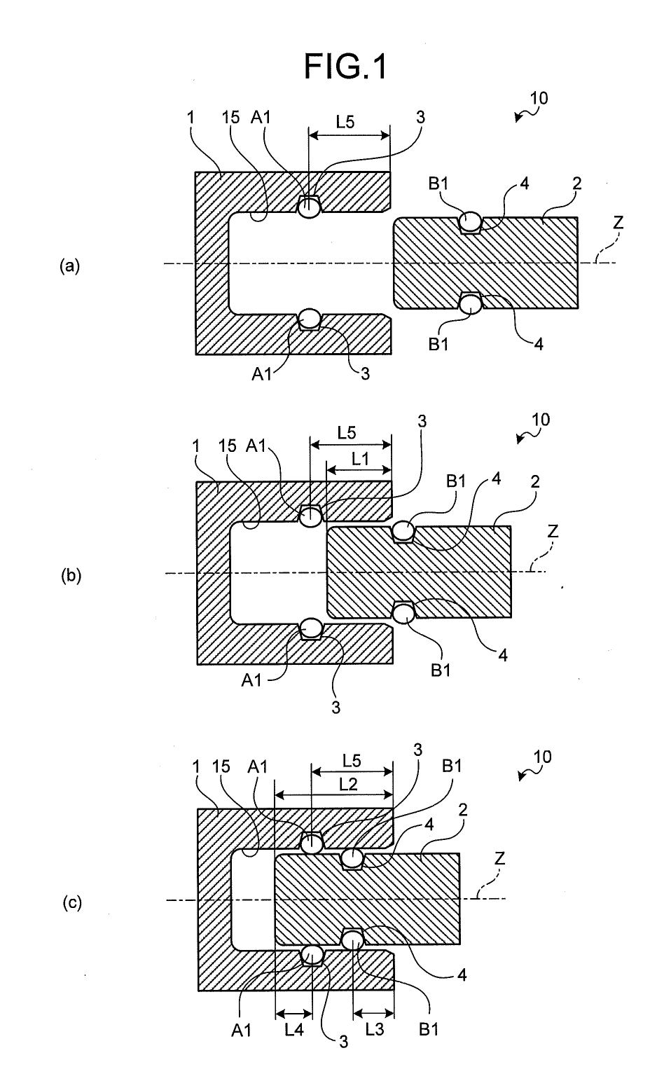

FIG. 1 is a series of vertical cross sectional views of a contact device 10 according to a first embodiment. The contact device 10 is used for, for example, an open-close section in a gas insulated switch. FIG. 1(a) shows an open state, FIG. 1(b) shows an intermediate closed state, and FIG. 1(c) shows a complete closed state.

As shown in FIG. 1(a), the contact device 10 includes, as main components: a pair of conductors being a conductor 1 (a second conductor) and a conductor 2 (a first conductor) that can form a current flow path; a conductive coil spring A1 (a second coil spring contact) fitted into an annular fitting groove 3 (a second fitting groove) formed circumferentially on the inner circumferential surface of the conductor 1; and a conductive coil spring B1 (a second coil spring contact) fitted into an annular fitting groove 4 (a first fitting groove) formed circumferentially on the outer circumferential surface of the conductor 2.

The conductor 1 is composed of a hollow conductive member having, for example, a cylindrical fitting hole 15 formed at its one end. The conductor 2 is composed of, for example, a cylindrical conductive member. The fitting hole 15 is formed to have an inner diameter slightly larger than the outer diameter of the conductor 2 so that the conductor 2 can be fitted into the fitting hole 15. The conductors 1 and 2 are disposed such that their center axes align with each other and therefore face each other on the same axis line Z. The conductors 1 and 2 are illustrated with their contact sections enlarged. For a gas insulated switch, the conductors 1 and 2 are each connected to a central conductor (not shown) to which a high voltage is applied. In the present embodiment, for example, the conductor 1 is fixed, while the conductor 2 is movable and can be reciprocally moved along the axis line Z by a driving unit (not shown).

The coil spring A1 is an example of the contact disposed on the conductor 1 and is formed by winding a conductive spring material wire obliquely and helically around a winding axis and bonding opposite ends of the wire. The fitting groove 3 is formed annularly along the inner circumferential surface of the conductor 1 and has a cross section having a width that decreases toward its bottom, for example. The coil spring A1 fitted into the fitting groove 3 has an ellipsoidal cross section. The top portion of the coil spring A1 protrudes from the fitting groove 3, and the coil spring A1 is in contact with the side surfaces of the fitting groove 3 and is thereby locked. As described above, the coil spring A1 comes into contact with the conductor 1 at two points to reduce the contact electric resistance. The same applies to the fitting groove 4 and the coil spring B1.

The operation of the present embodiment will next be described with reference to FIGS. 1(a) to 1(c). The closing operation will be described below. However, the isolating operation can be similarly described by following the closing operation in the reverse order.

In FIG. 1(a), the contact device 10 is in an open state, and the conductor 1 and the conductor 2 are not in electrical contact with each other and are separated from each other. The axial distance between the opening end of the conductor 1 and the center of the cross section of the coil spring A1 is denoted as L5. The rest of the configuration etc. is as described above.

Next, in FIG. 1(b), the contact device 10 is in an intermediate closed state. More specifically, the conductor 2 in the state shown in FIG. 1(a) is linearly moved in an axial direction by the driving unit and is brought into a state in which a part of the conductor 2 is inserted into the fitting hole 15. However, the coil spring A1 is not in contact with the conductor 2, and also the coil spring B1 is not in contact with the conductor 1, so that the conductors 1 and 2 are not in electric contact with each other. The axial distance between the opening end of the conductor 1 and the insertion end of the conductor 2 is denoted as L1.

Next, in FIG. 1(c), the movement of the conductor 1 for the fit is completed, and the contact device 10 is in a complete closed state, so that the conductors 1 and 2 are in an electrically connected state. More specifically, when the conductor 2 in the state shown in FIG. 1(b) is further driven, the coil spring B1 reaches the opening end of the conductor 1. Then the inner circumferential surface of the fitting hole 15 and the coil spring B1 come into sliding contact with each other. After the insertion end of the conductor 2 reaches the installation position of the coil spring A1, the outer circumferential surface of the conductor 2 and the coil spring A1 are in sliding contact with each other. The start order of the sliding contact between the coil spring B1 and the conductor 1 and the sliding contact between the coil spring A1 and the conductor 2 is determined by the magnitude relationship between L5 and the axial distance from the insertion end of the conductor 2 to the center of the cross section of the coil spring B1.

While the conductor 2 is driven, the coil spring B1 slides with the contact pressure between the coil spring B1 and the inner circumferential surface of the fitting hole 15 maintained, and the coil spring A1 slides with the contact pressure between the coil spring A1 and the outer circumferential surface of the conductor 2 maintained. When the conductor 2 is inserted to a predetermined position, the driving of the conductor 2 is stopped with a predetermined distance held between the coil spring A1 and the coil spring B1, as shown in FIG. 1(c). In FIG. 1(c), the coil spring A1 is in contact with the side surfaces of the fitting groove 3 and with the outer circumferential surface of the conductor 2 to allow electric contact between the conductor 1 and the conductor 2, and the coil spring B1 is in contact with the side surfaces of the fitting groove 4 and with the inner circumferential surface of the fitting hole 15 to allow electric contact between the conductor 1 and the conductor 2. The axial distance between the opening end of the conductor 1 and the insertion end of the conductor 2 is denoted as L2, the axial distance between the center of the cross section of the coil spring B1 and the opening end of the conductor 1 is denoted as L3, and the axial distance between the insertion end of the conductor 2 and the center of the cross section of the coil spring A1 is denoted as L4.

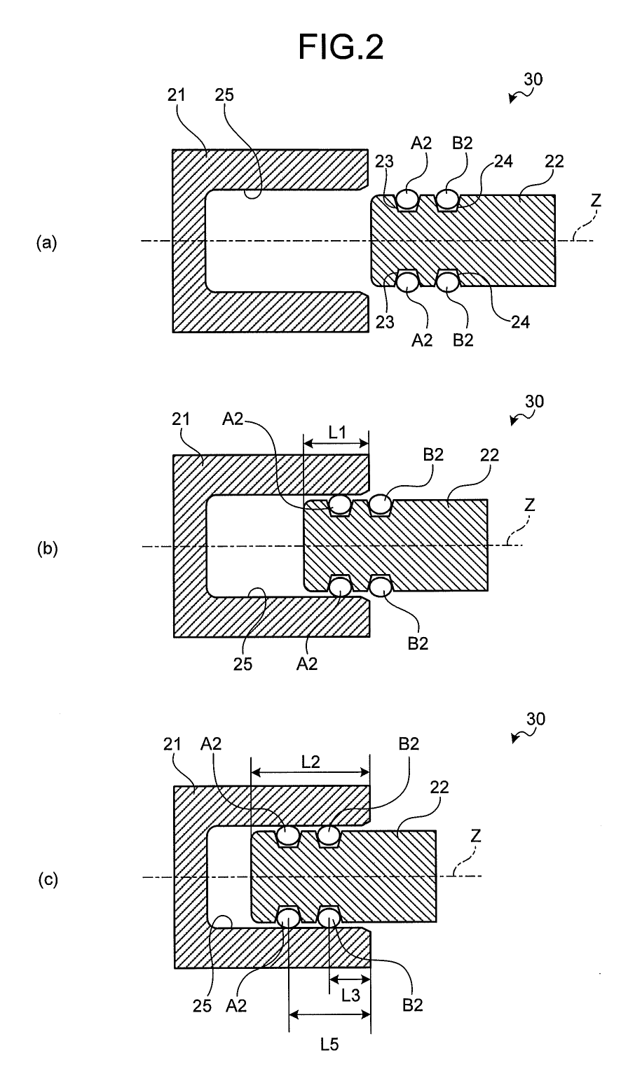

Preferably, the contact device 10 is configured such that L4<L5. More specifically, the axial distance (L5) from the center of the cross section of the coil spring A1 to the opening end of the conductor 1 is set to be longer than the axial distance (L4) from the center of the cross section of the coil spring A1 to the insertion end of the conductor 2. The reason that the above configuration is preferred will be described below by comparing the contact device 10 with a conventional contact device 30 shown in FIG. 2. FIG. 2 is a series of vertical cross sectional views of the conventional contact device 30.

As shown in FIG. 2(a), the conventional contact device 30 includes: a pair of conductors 21 and 22 that can form a current flow path; a conductive coil spring A2 that is fitted into an annular fitting groove 23 formed circumferentially on the outer circumferential surface of the conductor 22; and a conductive coil spring B2 that is fitted into an annular fitting groove 24 also formed circumferentially on the outer circumferential surface of the conductor 22.

The conductor 21 is composed of a hollow conductive member having, for example, a cylindrical fitting hole 25 formed at its one end. The conductor 22 is composed of, for example, a cylindrical conductive member. The fitting hole 25 is formed to have an inner diameter slightly larger than the outer diameter of the conductor 22 so that the conductor 22 can be fitted into the fitting hole 25. The conductors 21 and 22 are disposed such that their center axes align with each other and therefore face each other on the same axis line Z. The conductors 21 and 22 are illustrated with their contact sections enlarged. For a gas insulated switch, the conductors 21 and 22 are each connected to a central conductor (not shown) to which a high voltage is applied. The conductor 21 is fixed, and the conductor 22 is movable, i.e., can be reciprocally moved along the axis line Z by a driving unit (not shown).

As described above, in the conventional contact device 30, both the coil springs A2 and B2 are disposed on the movable conductor 22. The rest of the configuration is the same as that in FIG. 1(a).

The closing operation of the conventional contact device 30 will next be described with reference to FIGS. 2(a) to 2(c). In FIG. 2(a), the contact device 30 is in an open state, and the conductor 21 and the conductor 22 are not in electrical contact with each other and are separated from each other.

Next, in FIG. 2(b), the contact device 30 is in an intermediate closed state. More specifically, a part of the conductor 22 is inserted into the fitting hole 25, and only the coil spring A2 slides on the contact surface of the conductor 21. As described above, in the conventional technology, the coil spring A2 starts sliding at an intermediate point during the closing operation. However, in the present embodiment, the contacts of the coil springs A1 and B1 have not yet started sliding (FIG. 1(b)). Therefore, in the present embodiment, energy due to sliding operation in this time period is not generated. L1 in FIG. 2(b) is the same as L1 in FIG. 1.

Next, in FIG. 2(c), the contact device 30 is in a complete closed state, and the conductors 21 and 22 are in an electrically connected state. More specifically, when the conductor 22 in the state shown in FIG. 2(b) is further driven, the coil spring B2 subsequent to the sliding coil spring A2 slides on inner circumferential surface of the fitting hole 25. After the conductor 22 is inserted into the fitting hole 25 to a predetermined distance, the state shown in FIG. 2(c) is obtained. L2, L3, and L5 in FIG. 2(c) are the same as those in FIG. 1.

As shown in FIG. 2(c), in the conventional contact device 30, the sliding distance of the coil spring A2 during the period from the open state until the complete closed state is reached is L5, and the sliding distance of the coil spring B2 is L3. Therefore, the total sliding distance is (L3+L5). In the contact device 10 in the present embodiment as shown in FIG. 1(c), the sliding distance of the coil spring A1 during the period from the open state until the complete closed state is reached is L4, and the sliding distance of the coil spring B1 is L3. Therefore, the total sliding distance is (L3+L4). The arrangements of the contacts in the present embodiment and in the conventional technology are set to be the same in the complete closed state. In the present embodiment, therefore, the contact device 10 is configured such that L4<L5, so that (L3+L4) is less than (L3+L5). Therefore, the sliding distance of the contacts in the present embodiment is less than that in the conventional case. For example, if L3=L4 and L5=2×L3, the sliding distance of the contacts in the present embodiment is 2×L3, and the sliding distance of the contacts in the conventional technology is 3×L3.

As described above, in the present embodiment, the coil springs A1 and B1 serving as contacts are provided on the conductors 1 and 2, respectively. Therefore, when the conductors 1 and 2 are fitted together, the coil spring A1 slides on the outer circumferential surface of the conductor 2, and the coil spring B1 slides on the inner circumferential surface of the conductor 1. The fitting surface damage caused by sliding is thereby distributed to the inner circumferential surface and the outer circumferential surface. Therefore, an effect is demonstrated in that as compared with the conventional structure in which both the coil springs A2 and B2 are disposed on the conductor 22 as shown in FIG. 2, the damage to the fitting surfaces (to the inner circumferential surface, in comparison with FIG. 2) caused by sliding can be reduced.

On the other hand, in the conventional contact device 30, when the conductors 21 and 22 are fitted together, the coil spring A2 slides on the inner circumferential surface of the fitting hole 25, and then the coil spring B2 slides on the same sliding area. Therefore, the damage to the inner circumferential surface is doubled and increased. The same applies when both the coil springs A2 and B2 are disposed on the fixed conductor 21. Also in this case, the damage to the outer circumferential surface caused by sliding increases.

In the present embodiment, the contact device 10 is configured such that L4<L5. Therefore, the sliding distance of the contacts is smaller than that in the conventional contact device 30. This allows a reduction in the damage to the contacts and also a reduction in the energy of the driving unit.

The use of the coil springs A1 and B1 as contacts can reduce the contact resistance with the conductors 1 and 2. Therefore, heat generation is suppressed, and the flow of a large current is allowed without an increase in size of the contact device 10.

In the configuration of the present embodiment, one coil spring A1 and one coil spring B1 are provided as an example, but this is not a limitation. A plurality of coil springs A1 or coil springs B1 may be provided, or a plurality of coil springs A1 and a plurality of coil springs B1 may be provided, according to current capacity. For example, when two coil springs A1 are provided on the conductor 1, these coil springs A1 are disposed on the inner circumferential surface of the fitting hole 15 so as to be separated from each other by a predetermined distance in the axial direction. When a plurality of coil springs A1 are provided on the conductor 1, each coil spring A1 is disposed so as to satisfy the above condition L4<L5. More specifically, each coil spring A1 is configured such that the axial distance from the center of the cross section of the coil spring A1 to the opening end of the conductor 1 is longer than the axial distance from the center of the cross section of the coil spring A1 to the insertion end of the Conductor 2. This configuration has an advantage in that the sliding distance of the contacts is shorter than that in a conventional contact device having the same number of contacts.

In the present embodiment, the conductor 1 is fixed, and the conductor 2 is movable. However, the conductor 1 may be movable, and the conductor 2 may be fixed. In addition, both the conductors may be movable. Also in these cases, the same advantage as that described above can be obtained.

### Second Embodiment

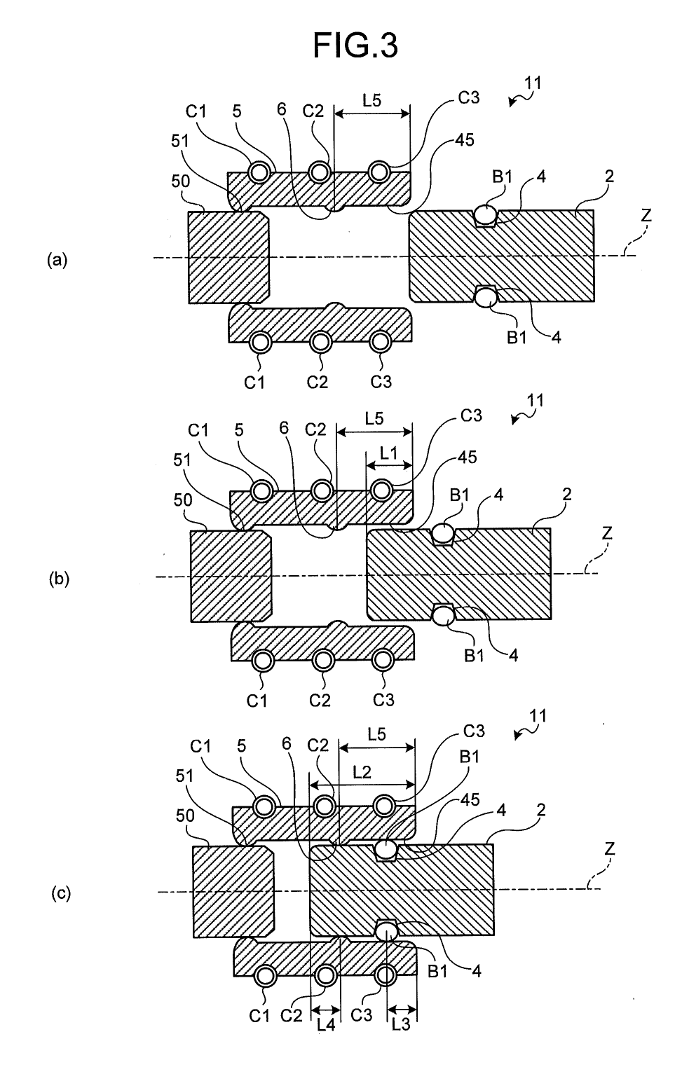

FIG. 3 is a series of vertical cross sectional views of a contact device 11 according to the present embodiment. FIG. 3(a) shows an open state, FIG. 3(b) shows an intermediate closed state, and FIG. 3(c) shows a complete closed state. In the first embodiment, the coil springs A1 and B1 are used as the contacts. In the present embodiment, instead of the coil spring A1, protrusions 6 provided on the inner surfaces of fixed conductors are used as contacts. In FIG. 3, the same components as those in FIG. 1 are denoted by the same reference numerals.

In FIG. 3, a plurality of mutually parallel conductors 5 extending in the direction of an axis line Z are provided. These conductors 5 are disposed on a circle about the axis line Z so as to be spaced apart from each other. Each of the conductors 5 has a protrusion 51 provided on its inner surface at one end, and the protrusion 51 is in contact with one end of the outer circumferential surface of a cylindrical conductor 50 disposed on the axis line Z. More specifically, these conductors 5 are circumferentially disposed at predetermined intervals so as to be in contact with the conductor 50, and a fitting hole 45 into which a movable conductor 2 can be inserted is thereby formed. A protrusion 6 is provided on the inner surface of each of the conductors 5, and the protrusions 6 are disposed on a single circle about the axis line Z. The outer circumferences of the plurality of conductors 5 are pressed by, for example, three springs C1 to C3 disposed annularly about the axis line Z. These springs C1 to C3 ensure the contact pressure between the protrusions 51 and the conductor 50 and urge the conductors 5 such that the diameter of the fitting hole 45 is reduced. In FIG. 3(c), the protrusions 6 urged by the springs C1 to C3 are in contact with the outer circumferential surface of the conductor 2 with contact pressure maintained. In the present embodiment, the plurality of conductors 5 and the conductor 50 form a second conductor. The conductors 2 and 50 are illustrated with their contact sections enlarged. For a gas insulated switch, the conductors 2 and 50 are each connected to a central conductor (not shown) to which a high voltage is applied.

The configuration of the present embodiment is the same as the configuration of the first embodiment except that the coil spring A1 is replaced with the protrusion 6. The operation in the present embodiment is the same as that in the first embodiment, and the same advantage can be demonstrated. For example, by setting L4<L5 as in the first embodiment, the sliding distance can be reduced as compared to that in the conventional contact device 30.

In the present embodiment, instead of the coil spring B1, a protrusion may be provided on the outer circumferential surface of the conductor 2 and used as a contact. Alternatively, a coil spring A1 may be used instead of the protrusions 6, and a protrusion may be used instead of the coil spring B1.

### Third Embodiment

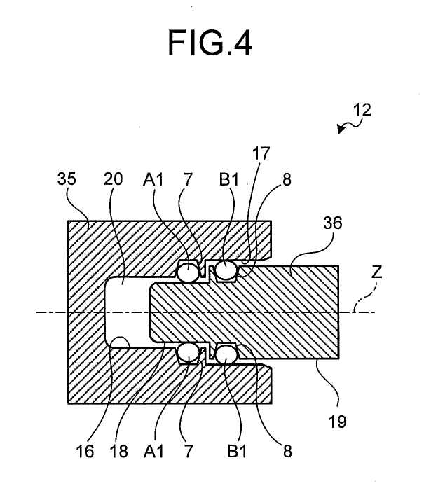

FIG. 4 is a vertical cross sectional view of a contact device 12 according to the present embodiment and shows a complete closed state. In FIG. 4, a movable conductor 36 has, for example, an end portion 18 serving as an insertion end and a base portion 19 having a diameter larger than the diameter of the end portion 18. A fixed conductor 35 has a fitting hole 20 into which the conductor 36 can be inserted, and the shape of the fitting hole 20 is designed so as to conform to the shape of the conductor 36, i.e., the bottom-side inner diameter near the bottom of the fitting hole 20 is smaller than the opening-side inner diameter near the opening end. Therefore, the inner circumferential surface of the fitting hole 20 includes a region 16 with the bottom-side inner diameter and a region 17 with the opening-side inner diameter.

The outer diameter of the end portion 18 is slightly smaller than the bottom-side inner diameter of the fitting hole 20. An annular fitting groove 7 is formed circumferentially on the region 16, and a coil spring A1 serving as a contact on the conductor 35 is fitted into the fitting groove 7. The coil spring A1 comes into contact with the side surfaces of the fitting groove 7 and with the outer circumferential surface of the end portion 18 to allow electrical contact between the conductors 35 and 36. The outer diameter of the base portion 19 is slightly smaller than the opening-side inner diameter of the fitting hole 20. An annular fitting groove 8 is formed circumferentially on the outer circumferential surface of the base portion 19, and a coil spring B1 serving as a contact on the conductor 36 is fitted into the fitting groove 8. The coil spring B1 comes into contact with the side surfaces of the fitting groove 8 and with the region 17 to allow electrical contact between the conductors 35 and 36.

The present embodiment is configured such that the distance from the center of the cross section of the coil spring A1 to the axis line Z is equal to the distance from the center of the cross section of the coil spring B1 to the axis line Z. In the first embodiment, on the other hand, the distance from the center of the cross section of the coil spring A1 to the axis line Z is larger than the distance from the center of the cross section of the coil spring B1 to the axis line Z. Therefore, in the first embodiment, the radial size of the contact device 10 is large. On the other hand, in the present embodiment, the radial distance can be reduced as compared with that in the first embodiment due to the above reason. The rest of the configuration and the operation in the present embodiment are the same as those in the first embodiment. In addition, the present embodiment can be easily combined with the second embodiment.

In the present embodiment, the shapes of the conductor 36 and the fitting hole 20 are different from those in the first embodiment. However, the present embodiment is same as the first embodiment in that the contacts are disposed on the pair of conductors, respectively, by disposing the coil spring A1 on the conductor 35, and disposing the coil spring B1 on the conductor 36. Therefore, the same advantage as that in the first embodiment can be demonstrated.

In the present embodiment, the distance from the center of the cross section of the coil spring A1 to the axis line Z is equal to the distance from the center of the cross section of the coil spring B1 to the axis line Z, so that the radial size of the contact device 12 can be smaller than that in the first embodiment. Therefore, in a gas insulated switch, the insulation distance from a metal container that contains the contact device 12 is reduced, and the diameter of the metal container can be reduced. This allows a further reduction in installation space of the gas insulated switch.

Also in the conventional contact device 30, the distance from the center of the cross section of the coil spring A2 to the axis line Z is equal to the distance from the center of the cross section of the coil spring B2 to the axis line Z. Therefore, according to the present embodiment, the contact device 12 has the same radial size as that of the contact device 30 and can hold similar current carrying performance.

### INDUSTRIAL APPLICABILITY

The present invention is useful as a contact device used for an open-close section of a gas insulated switch.

1. A contact device comprising a first conductor and a second conductor disposed with the first conductor on a common axis and having a fitting hole into which the first conductor can be inserted, at least one of the first and second conductors being axially moved to fit the first and second conductors together so that a current is allowed to flow between the first and second conductors through contacts, the contact device further comprising
a conductive first contact that is disposed circumferentially on an outer circumferential surface of the first conductor and is contactable with an inner circumferential surface of the fitting hole, and
a conductive second contact that is disposed circumferentially on the inner circumferential surface of the fitting hole and is contactable with the outer circumferential surface of the first conductor.

2. The contact device according to claim 1, wherein the first contact is a first coil spring contact that is fitted into a first annular fitting groove formed circumferentially on the outer circumferential surface of the first conductor, and the second contact is a second coil spring contact that is fitted into a second annular fitting groove formed circumferentially on the inner circumferential surface of the fitting hole.

3. The contact device according to claim 1, wherein, after relative movement of the first and second conductors is completed and the first and second conductors are fitted together, an axial distance from a center of a cross section of the second contact to an opening end of the second conductor is longer than an axial distance from the center of the cross-section of the second contact to an insertion end of the first conductor.

4. The contact device according to claim 1, wherein
the first conductor includes a base portion and an end portion having an outer diameter smaller than an outer diameter of the base portion,
the fitting hole has inner diameters including a bottom-side inner diameter larger than the outer diameter of the end portion and an opening-side inner diameter that is larger than the outer diameter of the base portion and larger than the bottom-side inner diameter,
the first contact is disposed on an outer circumferential surface of the base portion, and
the second contact is disposed on the inner circumferential surface and positioned in a region having the bottom-side inner diameter.

5. The contact device according to claim 4, wherein a distance from a center of a cross section of the first contact to the common axis is equal to a distance from a center of a cross section of the second contact to the common axis.

6. The contact device according claim 1, wherein the contact device is used for an open-close section of a gas insulated switch.

7. The contact device according to claim 2, wherein, after relative movement of the first and second conductors is completed and the first and second conductors are fitted together, an axial distance from a center of a cross section of the second contact to an opening end of the second conductor is longer than an axial distance from the center of the cross-section of the second contact to an insertion end of the first conductor.

8. The contact device according to claim 2, wherein
the first conductor includes a base portion and an end portion having an outer diameter smaller than an outer diameter of the base portion,
the fitting hole has inner diameters including a bottom-side inner diameter larger than the outer diameter of the end portion and an opening-side inner diameter that is larger than the outer diameter of the base portion and larger than the bottom-side inner diameter,
the first contact is disposed on an outer circumferential surface of the base portion, and
the second contact is disposed on the inner circumferential surface and positioned in a region having the bottom-side inner diameter.

9. The contact device according to claim 3, wherein
the first conductor includes a base portion and an end portion having an outer diameter smaller than an outer diameter of the base portion,
the fitting hole has inner diameters including a bottom-side inner diameter larger than the outer diameter of the end portion and an opening-side inner diameter that is larger than the outer diameter of the base portion and larger than the bottom-side inner diameter,
the first contact is disposed on an outer circumferential surface of the base portion, and
the second contact is disposed on the inner circumferential surface and positioned in a region having the bottom-side inner diameter.

10. The contact device according to claim 8, wherein a distance from a center of a cross section of the first contact to the common axis is equal to a distance from a center of a cross section of the second contact to the common axis.

11. The contact device according to claim 9, wherein a distance from a center of a cross section of the first contact to the common axis is equal to a distance from a center of a cross section of the second contact to the common axis.

12. The contact device according to claim 2, wherein the contact device is used for an open-close section of a gas insulated switch.

13. The contact device according to claim 3, wherein the contact device is used for an open-close section of a gas insulated switch.

14. The contact device according to claim 7, wherein the contact device is used for an open-close section of a gas insulated switch.

15. The contact device according to claim 5, wherein the contact device is used for an open-close section of a gas insulated switch.

16. The contact device according to claim 8, wherein the contact device is used for an open-close section of a gas insulated switch.

17. The contact device according to claim 9, wherein the contact device is used for an open-close section of a gas insulated switch.

18. The contact device according to claim 5, wherein the contact device is used for an open-close section of a gas insulated switch.

19. The contact device according to claim 10, wherein the contact device is used for an open-close section of a gas insulated switch.

20. The contact device according to claim 11, wherein the contact device is used for an open-close section of a gas insulated switch.
